(19) United States
(12) Patent Application Publication
(10) Pub. No.: US 2011/0298767 A1
(43) Pub. Date: Dec. 8, 2011

(54) LIQUID CRYSTAL DISPLAYS

(76) Inventors: Mike O'Callaghan, Louisville, CO (US); Cory Pecinovsky, Longmont, CO (US)

(21) Appl. No.: 12/794,267

(22) Filed: Jun. 4, 2010

(51) Int. Cl. G09G 3/36; H01J 9/24; G06F 3/038

(52) U.S. Cl. 345/208; 345/87; 345/97; 445/24

(57) ABSTRACT

Electronic apparatus, systems, and methods to operate a liquid crystal display provide a mechanism that can be used to address image sticking on the display. The mechanism may be provided in the form of an arrangement of a liquid crystal and an insulating material, where the arrangement has a decay time constant that is comparable to or less than a maximum time visually acceptable for image sticking to persist. Additional apparatus, systems, and methods are disclosed.

### BACKGROUND

Liquid crystals are widely used in displays, ranging from simple alpha-numeric displays to computer displays and televisions. Although nematic liquid crystals are used in the vast majority of these applications, the performance advantages of ferroelectric liquid crystals (FLCs) has led to their adoption in liquid crystal on silicon microdisplays, which have found use in electronic viewfinders and picoprojectors (see Clark, N. A., C. Crandall, M. A. Handschy, M. R. Meadows, R. M. Malzbender, C. Park, and J. Z. Xue, FLC microdisplays, in Ferroelectrics, 2000, 246, p. 97-110, and Handschy, M. A. and B. F. Spenner, The future of pico projectors, in Information Display. December 2008. p. 16-20.). Due to their high switching speed, FLCs are well suited to the frame sequential color operating mode in which each pixel is capable of reproducing a full range of color (see Handschy, M. A. and J. Dallas, 9.5L: Late-News Paper: Scalable Sequential-Color Display Without ASICs, SID Symposium Digest of Technical Papers, 2007. 38(1): p. 109-112.). Images to be displayed are separated into their red, green, and blue, components, and the three individual monochrome images are displayed in quick sequence. The display (acting in reflection or transmission) is synchronously illuminated with corresponding red, green, or blue light. When displayed at a high enough rate, viewers are not aware of the individual monochrome images but instead see them merged together as a full color image. This is in contrast to more common displays that contain separate sets of red, green, and blue, pixels which are operated simultaneously to produce full color images. In this more common type of display, the image resolution is typically one third of the total number of pixels, whereas in frame sequential color displays the resolution is equal to the total number of pixels, resulting in higher quality images.

One phenomenon of liquid crystal displays, such as those of the ferroelectric type, is termed “image sticking,” also known as “optical hysteresis” or “ghost images,” referring to a residual image that is displayed on the screen persisting long after the driving voltages are removed from the ferroelectric liquid crystal (FLC) pixels. It is believed that ions present in the liquid crystal can contribute to the image sticking problem. In general, the average (dc) voltage applied to a pixel during a sequence of images will be non-zero, the exact value depends on the image content and can vary from pixel to pixel. A non-zero average voltage causes severe image sticking, but operation in a DC balanced mode, which forces the average voltage to be zero, can reduce image sticking. DC balancing refers to the process wherein a voltage of inverse polarity is applied to a liquid crystal pixel immediately following application of a display voltage to assist in neutralizing residual electrical charges responsible for image sticking. However, this mode of operation requires that the LEDs supplying the light that is modulated by the FLCs be turned off during the balance phase when the inverse polarity voltage is applied, thereby reducing the light output of the device. See, for example U.S. Pat. No. 6,075,577.

Images are produced on an FLC display by applying a suitable pattern of voltages to the display's pixels and viewing the resultant pattern of FLC optical states using crossed polarizers. In standard video systems, the displayed image changes at a rate of 60 frames per second. Under certain conditions, an image can become “stuck” for a time; meaning that when subsequent images are displayed, the stuck image is superimposed on those later images.

### BRIEF DESCRIPTION OF THE DRAWINGS

Embodiments of the invention are illustrated by way of example and not limitation in the figures of the accompanying drawings in which:

FIG. 1 illustrates an apparatus having a liquid crystal display, according to various embodiments.

FIG. 2A illustrates a ferroelectric liquid crystal cell, according to various embodiments.

FIG. 2B illustrates a liquid crystal containing resistive elements, according to various embodiments.

FIG. 3 shows a simplified equivalent circuit of a ferroelectric liquid crystal cell having a ferroelectric liquid crystal between two alignment layers, according to various embodiments.

FIG. 4 shows an equivalent circuit derived from the equivalent circuit of FIG. 3 based on selections of the materials used and the structural characteristics of the layers used for the ferroelectric liquid crystal and alignment layers, according to various embodiments.

FIG. 5A shows idealized examples of drive waveforms applied to a pixel's electrodes with duty cycles ranging from 10% to 90%, in accordance with various embodiments.

FIG. 5B shows illustrations of voltages appearing across the ferroelectric liquid crystal layer corresponding to the drive waveforms of FIG. 5A, in accordance with various embodiments.

FIG. 6 illustrates optic axis orientations of a ferroelectric liquid crystal for positive and negative drive voltages, in accordance with various embodiments.

FIG. 7A is a graph of optic axis orientations for positive and negative drive voltages versus drive waveform duty cycle for ferroelectric liquid crystal cells with and without added ionic conductivity, in accordance with various embodiments.

FIG. 7B is a graph showing the difference between optic axis orientation for positive voltage and optic axis orientation for negative drive voltages versus duty cycle for the ferroelectric liquid crystal cells of FIG. 7A, in accordance with various embodiments.

FIG. 8A shows measurements of applied drive cell voltage, ferroelectric liquid crystal cell electrical current, and optical response versus time for a base ferroelectric liquid crystal without added ionic conductivity, in accordance with various embodiments.

FIG. 8B shows measurements of applied drive cell voltage, ferroelectric liquid crystal cell electrical current, and optical response versus time for a base ferroelectric liquid crystal similar to that of FIG. 8A, but with added ionic conductivity, in accordance with various embodiments.

FIG. 9A shows measurements of applied drive cell voltage, ferroelectric liquid crystal cell electrical current, and optical response versus time for the base ferroelectric liquid crystal without added ionic conductivity of FIG. 8A at a drive waveform having a higher period than the drive waveform used for FIG. 8A.

FIG. 9B shows measurements of applied drive cell voltage, ferroelectric liquid crystal cell electrical current, and optical response vs. time for the base ferroelectric liquid crystal cell ion-doped of FIG. 8B at a drive waveform having a higher period than the drive waveform used for FIG. 8B.

FIG. 10A shows results of changing duty cycles applied to a ferroelectric liquid crystal with low ion concentration, in accordance with various embodiments.

FIG. 10B shows results of changing duty cycles applied to a ferroelectric liquid crystal with high ion concentration, in accordance with various embodiments.

FIGS. 11A-B show an example representation of operation of a ferroelectric liquid crystal cell with a set of polarizers, in accordance with various embodiments.

FIG. 12 shows an example representation of components for operation a ferroelectric liquid crystal, in accordance with various embodiments.

### DETAILED DESCRIPTION

The following detailed description refers to the accompanying drawings that show, by way of illustration, and not limitation, various embodiments of the invention. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

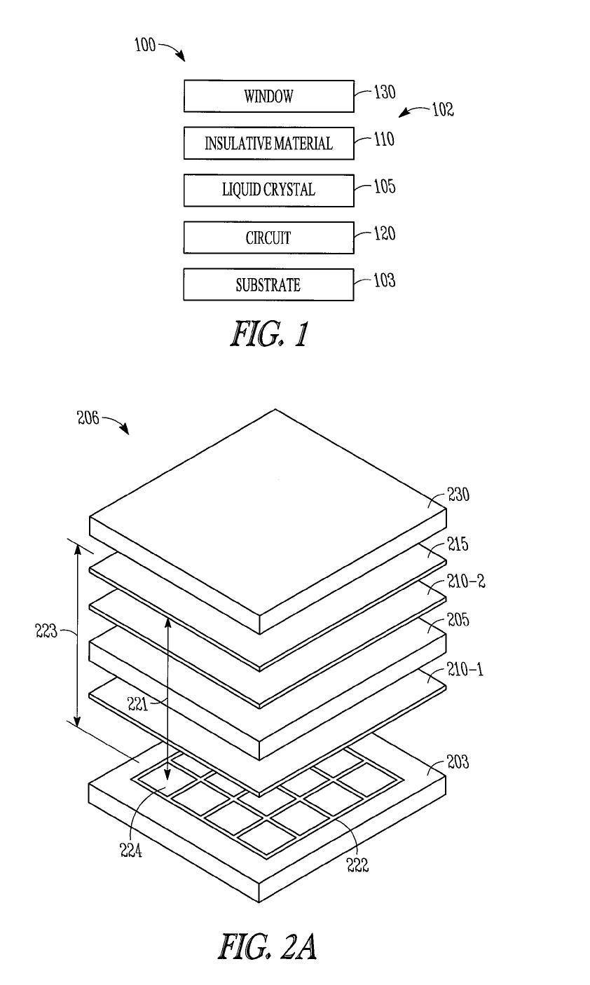

FIG. 1 illustrates an embodiment of an apparatus 100 having a liquid crystal display 102. Liquid crystal display 102 includes a liquid crystal 105 coupled to a structure having an insulating material 110 such that combination of liquid crystal 105 and insulating material 110 has a decay time constant less than a maximum time visually acceptable for image sticking to persist on the liquid crystal display. The decay time constant is a non-zero time in which charge associated with liquid crystal 105 and insulating material 110 can accumulate or can be discharged relative to applied electric fields. Liquid crystal display 102 can be a nematic liquid crystal. Liquid crystal display 102 can be a ferroelectric liquid crystal. The ferroelectric liquid crystal can be part of a cell in which the insulating material, to which the ferroelectric liquid crystal is coupled, is a portion of an alignment layer.

The decay time constant can be realized by setting the resistance associated with liquid crystal 105 such that the combination of liquid crystal 105 and insulating material 110 provide a decay time constant that is in a range that is visually acceptable for image sticking to persist on the liquid crystal display. This range may be from about 1 second to about 2 seconds. This range may be less than about 1 second. The decay time constant may be less than a minimum time at which image sticking is noticeable to a human viewer of the liquid crystal display. The decay time constant may be equal to less than one-thirtieth of a second.

To attain these ranges, different approaches can be used to adjust the resistance associated with liquid crystal 105. Liquid crystal 105 can be used that have amounts of various materials incorporated with the base liquid crystal. A ferroelectric liquid crystal can be doped with ions to adjust the conductivity, hence resistivity, of the ferroelectric liquid crystal. In another approach, liquid crystal 105 can be disposed in a region of a structure that includes resistive material, in addition to the liquid crystal, that significantly contributes to the decay time constant of the combination of liquid crystal 105 and insulating material 110. Alternatively, for a given liquid crystal, an insulating material can be selected for insulating material 110 in which the insulating material has a capacitance such that the combination of liquid crystal 105 and insulating material 110 generates a decay time constant within the visually acceptable range. As a non-limiting example, an insulating material, configured as an alignment layer for a ferroelectric liquid crystal, can have a capacitance such that the decay time constant is about one-half the product of the electrical resistance of the ferroelectric liquid crystal and a capacitance associated with the capacitance of the alignment layer. The capacitance associated with the capacitance of the alignment layer may be set to the capacitance of the alignment layer by design of the structure and selection of material components of the structure. The decay time constant can also be selected to be greater than or equal other operational parameters for the liquid crystal display, while at the same time being in a range that is visually acceptable for image sticking to persist on the liquid crystal display. The decay time constant can be selected to be greater than a time to switch a ferroelectric liquid crystal between substantially contrasting display states.

Liquid crystal display 102 can be realized as a ferroelectric liquid crystal display 102. Ferroelectric liquid crystal display 102 can include a number of cells, where each cell includes a ferroelectric liquid crystal 105 coupled to an alignment layer 110. A FLC consists of elongated molecules that, on average, align themselves parallel to one another. This direction is referred to as the director of the liquid crystal. Films formed from FLCs exhibit optical birefringence, with the optic axis approximately parallel to the FLC molecule's orientation. The molecules self-organize into smectic layers, that is, they tend to align themselves in layers or planes. The molecular axes tilt away from the layer normal by an amount determined by the molecular properties of the FLC mixture. This characteristic angle is known as the FLC's tilt angle θ_{T}. The direction of tilt is arbitrary, where the range of allowable orientations defines a cone. Further, the FLC possesses an electric dipole moment, which is perpendicular to the long molecular axis and lies parallel to the smectic plane. An electric field can be used to apply torques to the FLC dipole, enabling the molecular axis to be set to any position on the cone. An alignment layer at the boundary of the FLC is a material whose anisotropy determines an initial orientation for the FLC molecules such as to induce a particular director orientation.

In various embodiments, a cell of ferroelectric liquid crystal display 102 has a decay time constant that is less than a maximum time visually acceptable for image sticking to persist on the display. The decay time constant may be comparable to or less than a minimum time for detection of image sticking perceived with human vision, where an individual viewing the display is essentially unaware of the occurrence of the image sticking.

Ferroelectric liquid crystal display 102 can be structured on a substrate 103 in which circuit 120 is disposed. Ferroelectric liquid crystal display 102 can include an array of cells having a ferroelectric liquid crystal and alignment layer incorporated with a single integrated circuit, often referred to as a chip. The incorporation of ferroelectric liquid crystal and alignment layer on a chip allows for the use of various microelectronic fabrication techniques to be employed in constructing ferroelectric liquid crystal display 102. The construction can include disposing a window 130 for optical output above alignment layer 110.

The selection and fabrication of the ferroelectric liquid crystal and alignment layer can be realized such that the decay time constant is about one-half the product of the capacitance of the alignment layer and the electrical resistance of the ferroelectric liquid crystal layer. The decay time constant can be less than a fraction of a second. The decay time constant can be less than one-thirtieth of a second. In addition, the decay time constant can be greater than a time to switch the ferroelectric liquid crystal between display states. The selection of the decay time and the selection of the ferroelectric liquid crystal and alignment layer may depend on the application for the ferroelectric liquid crystal display.

Multiple mechanisms can contribute to image sticking: charge accumulation at FLC-alignment layer interfaces, changes in director orientation at the alignment layer, changes of pretilt, and possibly changes in director gliding behavior. With respect to accumulation of electrical charge at the surfaces of the FLC layer in response to applied voltages, as judged by the appearance of image sticking, the time constant for growth and decay of accumulated surface charge typically ranges from minutes to hours. To combat this problem, FLC displays have been operated to generally show each image and its complement in sequence (i.e. dark pixels made bright and vice versa). This process is conducted to essentially ensure that the average voltage experienced by each pixel of the FLC display is zero. As a result, no charge should accumulate, assuming that the charge accumulation time is long compared to the frame period. The disadvantage of this scheme, referred to here as dc-compensation, is that illumination is turned off during display of the image complement so that it is substantially unseen by viewers. The resulting 50% duty cycle reduces the effective display brightness by half Duty cycle is defined as the proportion of time that the liquid crystal is driven so as to display the image. This is the maximum time that it is desirable to illuminate a display. For various reasons, it may not be desirable to illuminate the display for the entire period that the liquid crystal is driven so as to display the image.

In various embodiments, rather than eliminating ions in an FLC or at an FLC-alignment layer interface, the FLC can be formed as a base FLC with ions added to dope the base FLC to adjust its conductivity (resistivity). The FLC display can be structured and operated, not necessarily to eliminate image sticking, but instead to force the decay time of the image sticking, which is a non-zero time, to be comparable to or less than a minimum time for detection of image sticking perceived with human vision. A time at which a human is visually aware of an object in direct view may be referred to as the persistence time of human vision, τᵥᵢₛᵢₒₙ. The persistence time of human vision may vary, for various reasons, within a range about approximately 1/30^{th} of a second. Forcing the decay time of the image sticking to such a timeframe hides rather than eliminates image sticking. The FLC display, or other liquid crystal display, can be structured and operated to force the decay time of the image sticking to be comparable to or less than a minimum time for image sticking to be noticeable to a human viewer of the display. Alternatively, the structured decay time may be within a maximum time visually acceptable for image sticking to persist on the FLC display. The effective display brightness can be increased by enabling duty cycles greater than 50% without introducing unacceptable levels of image sticking.

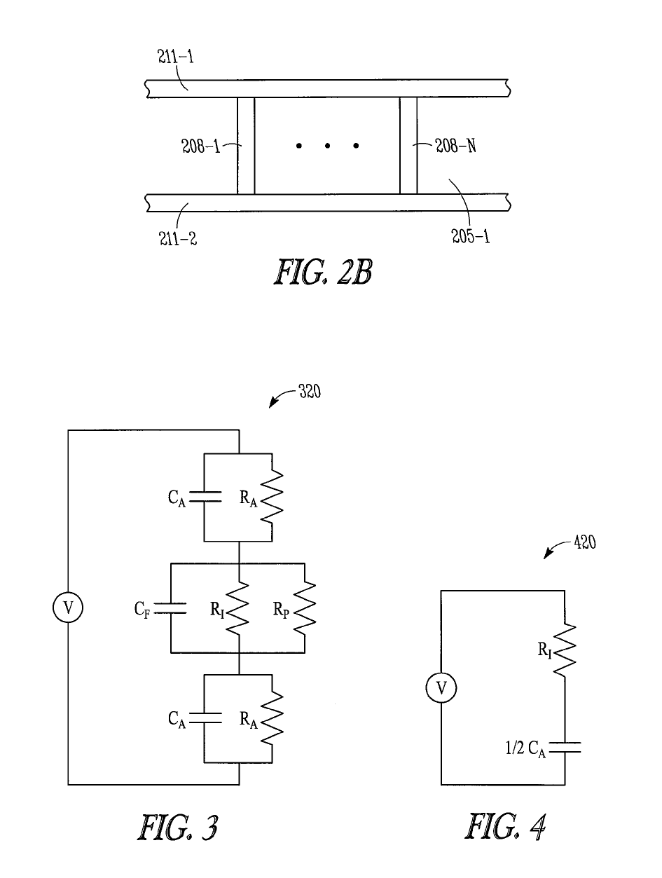

FIG. 2A illustrates an embodiment of a ferroelectric liquid crystal cell 206. FLC cell 206 includes a FLC 205 between two alignment layers 210-1 and 210-2. FLC 205 and alignment layers 210-1 and 210-2 are arranged in an electrical circuit with pixel 224 of an array 222 of pixels on a substrate. Composition and structure of FLC 205 and alignment layers 210-1 and 210-2 can be chosen such that the arrangement of FLC 205 and the two alignment layers 210-1 and 210-2 has a decay time constant, relative to operation in the electrical circuit, that is comparable to or less than a maximum time visually acceptable for image sticking to persist on the liquid crystal display. The decay time constant may be less than a minimum time at which image sticking is noticeable to a human viewer of the liquid crystal display.

Alignment layer 210-1 is disposed above array 222 such that an electric field 221 can be generated across the arrangement of FLC 205 and the two alignment layers 210-1 and 210-2 with a potential, V, 223 applied between pixel 224 and a contact 215 to alignment layer 210-2. For example, electric field 221 can be applied as approximately ±1.65 V/μm with 1.65 V applied to contact 215 and 0 V or 3.3 V applied to pixel 224. Other electric fields may be used by applying appropriate voltages to contact 215 and pixel 224. An electrical circuit on substrate 203 can include a source to apply a pulse-width modulation to the arrangement of FLC 205 and the two alignment layers 210-1 and 210-2.

A transparent conductive material can be used for contact 215. The transparent conductive material may comprise a transparent conductive oxide (TCO) such as indium tin oxide, referred to as ITO. Other TCOs may be used. FLC cell 206 can include a window 230 for passage of light. The representation of FLC cell 206 in FIG. 2 shows the various regions of FLC cell 206 as separated layers on a portion of substrate 203. However, these layers can be formed as an integrated cell on substrate 203, where substrate 203 can include additional circuitry with which FLC cell 206 is an integrated component. Potential 223 can be applied using metallization of the integrated circuit on substrate 203 to appropriate sources to generate the desired potential 223. Substrate 203 can be a VLSI (very large scale integration) circuit formed by complementary metal oxide semiconductor (CMOS) fabrication techniques. A silicon substrate can be used for substrate 203. An aluminum pad may be disposed on CMOS VLSI circuitry on which the FLC is disposed. The aluminum pad can provide a reflective surface for FLC cell 206. A FLC display using underlying circuits on silicon is referred to as a FLCOS display. Materials other than silicon can be used as substrates depending on the application.

FIG. 2B illustrates a liquid crystal 205-1 containing resistive elements 208-1 . . . 208-N. Resistive elements 208-1 . . . 208-N can be arranged to extend between a top surface and a bottom surface of liquid crystal 205-1. Liquid crystal 205-1 with resistive elements 208-1 . . . 208-N effectively provides a liquid crystal with an adjusted resistivity. Further, liquid crystal 205-1 may optionally include added material that effectively dopes liquid crystal 205-1 to provide liquid crystal 205-1 with an adjusted conductivity (resistivity). Liquid crystal 205-1 can be realized a ferroelectric liquid crystal. Resistive elements 208-1 . . . 208-N can be structured with materials and with a shape that is compatible with liquid crystal 205-1 and does not appreciatively affect the functional activity of liquid crystal 205-1. Use of resistive elements 208-1 . . . 208-N in the design of a liquid crystal display can allow for an additional parameter that can be used to set a decay time constant relative to an acceptable level of image sticking to persist on the associated display.

Resistive elements 208-1 . . . 208-N can be structured to effectively punch through liquid crystal 205-1 to couple a transparent conductive layer 211-1 to another transparent conductive layer 211-2. Such an arrangement of resistive elements 208-1 . . . 208-N in liquid crystal 205-1 coupling transparent conductive layers 211-1 and 211-2 may be used in the structure shown in FIG. 2A replacing liquid crystal 205. Each resistive elements 208-j (for each j from 1 to N) can be assigned to a different pixel 224 of array 222. Further, conductive layers 211-1 and 211-2 can be patterned coinciding with the pattern of array 222 such that for each respective pixel 224, there is a resistive element 208-j aligned within the patterned section for pixel 224. An example pattern is shown as, but is not limited to, squares in array 222 in FIG. 2A. Resistive element 208-j may be aligned with a center of pixel 224. Resistive element 208-j is not limited to being located above a center of a pixel, but may be located at any location above a pixel within its respective region of array 222.

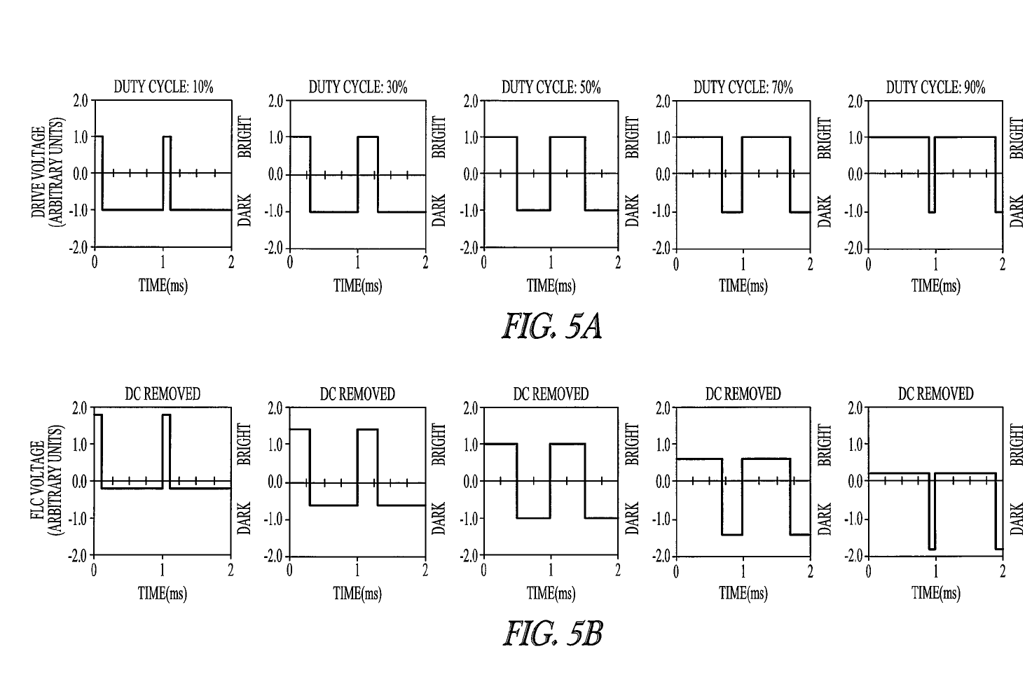

FIG. 3 shows a simplified equivalent circuit 320 of a FLC cell having a FLC between two alignment layers, such as FLC cell 206 shown in FIG. 2. Each alignment layer is represented as a resistance R_{A} and capacitance C_{A} connected in parallel. Similarly, the FLC layer can be represented as a capacitance C_{F} in parallel with a non-linear, history-dependent resistor. The dominant contributions to the FLC's conductivity are the motion of ionic charge carriers (represented by R₁) and the flow of the FLC's polarization charge (represented by R_{P}). The ionic charge flow contribution to the FLC's resistance is influenced by ionization and recombination rates in the bulk, by the dynamics of ionic adhesion/release by surfaces, and by time-dependent spatially varying ion/source densities within the thickness of the FLC layer. These mechanisms for ionic charge flow and their relative importance can vary strongly with temperature.

The material for the alignment layers and the material for the FLC can be selected such that the alignment layer resistance is much greater than that of the FLC. In such cases, the resistance R_{A} of the alignment layer can be set to R_{A}=∞ in equivalent circuit 320, which effectively provides that resistance R_{A} can be omitted from equivalent circuit 320. The alignment layer is generally thin compared to the FLC. For example, the thickness of an alignment layer may typically be 20 nm, while the thickness of the FLC may be 800 nm. Other thicknesses can be used. With such differences in thickness, the capacitance C_{A} of an alignment layer is approximately one to two orders of magnitude larger than capacitance C_{F} of the FLC. Further, after FLC switching events, where the polarization switching current is near zero, the FLC's conductivity is dominated by the motion of ionic charge carriers, which conductivity is represented by R₁ in the equivalent circuit.

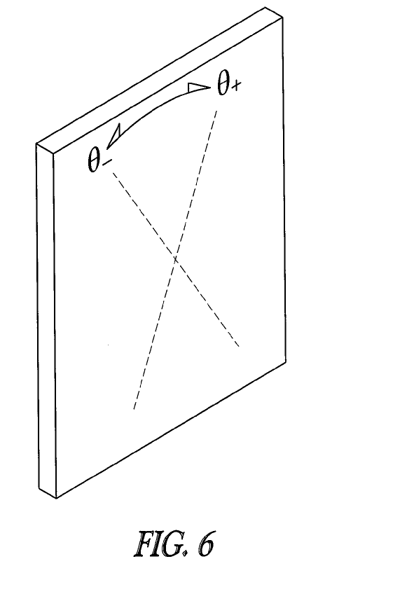

FIG. 4 shows an equivalent circuit 420 derived from equivalent circuit 320 of FIG. 3 based on selections of the materials used and the structural characteristics of the layers used for the FLC and alignment layers. As a consequence of C_{A}>>C_{F}, R_{A}≈∞, and R₁<<R_{P}, a first approximation to the electrical time constant of interest is ½R₁C_{A}. Alternatively, the two alignment layers may have different capacitances, where C_{1A} refers to the capacitance of one individual alignment layer, and C_{2A} refers to the capacitance of the other individual alignment layer. With these capacitances significantly greater than C_{F}, C_{A}, in the time constant ½R₁C_{A}, refers to C_{A}=2/(1/C_{1A}+1/C_{2A}). The time constant ½R₁C_{A} can be adjusted by selection of the materials of the FLC and alignment layers, selection of the structural characteristics such as thickness for these layers, or combinations of these selections. In an example embodiment, ½R₁C_{A} can be adjusted by adding ionizable compounds to a selected base FLC in order to lower R₁ compared to that of an ionically clean version of the selected base FLC. The ionizable compounds can include an ion pair of molecules, where one molecule is a cation and the other molecule of the pair is an anion. For example, the following ion pair compounds may be used as dopants in a base FLC:

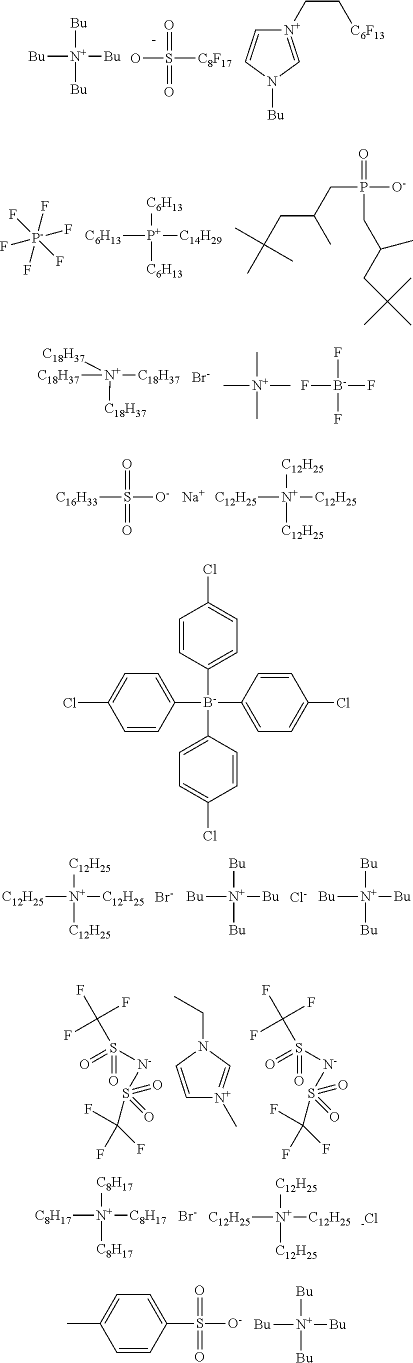

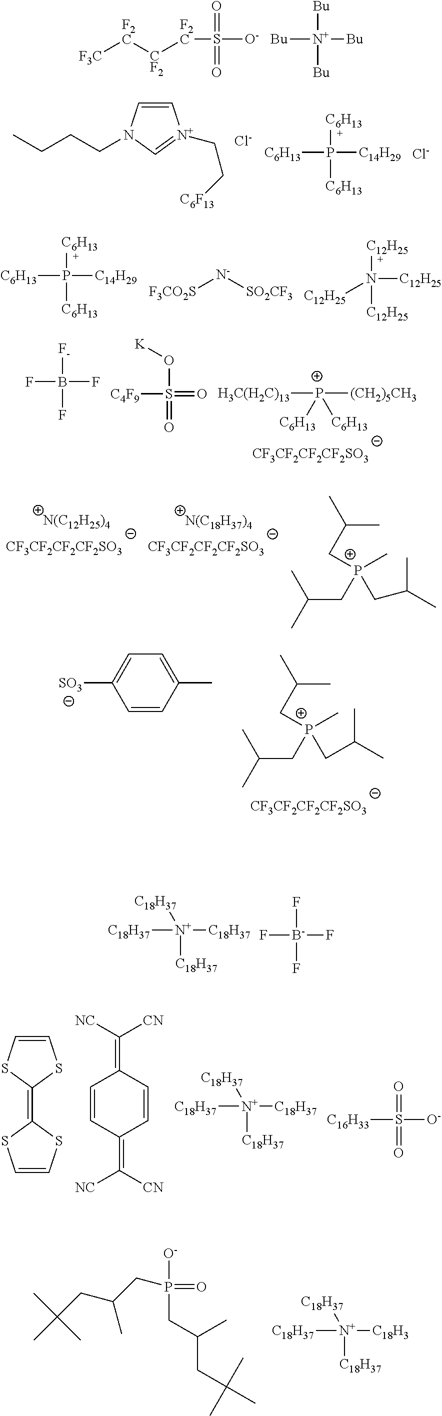

or any mixture thereof. The concentration of the ion pair compound in the FLC composition can be from about 0.05 wt % to about 0.15 wt %. Other ionic doping and/or concentrations may be used.

The FLC cell acts as an electrical high pass filter, where high frequency components of a drive waveform are felt by the FLC, but the alignment layer capacitance blocks the dc component. The average voltage applied across the FLC resistance can be zero in this simplified situation, thus avoiding charge accumulation. In effect, the high pass character of the FLC cell equivalent circuit enforces dc-balance on the FLC layer even when the drive waveform applied to the complete cell is not dc-balanced.

Whenever the dc component of an applied waveform changes, for example, due to changing the image being shown by the associated microdisplay, the dc voltage across the FLC resistance briefly becomes non-zero, but decays back to zero with a time constant equal to ½R₁C_{A}. The time constant is essentially set by capacitance of the alignment layers and the electrical resistivity of the ferroelectric liquid crystal, where the electrical resistivity of the ferroelectric liquid crystal controlled by motion of ionic charges. By selecting the base FLC and/or by doping a selected base FLC with ions, R₁ can be adjusted to set ½R₁C_{A}< 1/30^{th} second, for example, so that the dc term (representing the “stuck” image) decays away fast enough that it would not be apparent to the viewer.

A ferroelectric liquid crystal can be disposed in a FLC cell having an electrical resistivity less than an upper electrical resistivity, or threshold electrical resistivity, where the upper electrical resistivity is set both by the capacitance fixed by using a selected material with a selected thickness as the alignment layer and by the decay time constant set comparable to or less than a maximum time visually acceptable for image sticking to persist on the liquid crystal display. The decay time constant may be less than a minimum time at which image sticking is noticeable to a human viewer of the liquid crystal display. Alternatively, for a given FLC having a given R₁, the decay time constant can be adjusted by selecting a value of C_{A} to produce the desired decay time constant. The selected value of C_{A} can be attained by selection of the material for the alignment layers and/or one or more structure characteristics of the alignment layers. The structure characteristic considered can be the thickness of the alignment layers.

Another consideration for selection of the characteristics of the FLC and alignment layers includes selecting the decay time constant, ½R₁C_{A}, such that it is substantially longer than the time, τ_{SW}, to switch the liquid crystal between display states (e.g. bright to dark, comprising substantially contrasting display states). Otherwise, the FLC may not switch fully and images may not be displayed. Combining these two factors for an appropriate decay time, the condition, τ_{SW}<½R₁C_{A}<τᵥᵢₛᵢₒₙ, can be used to select materials and sizes for the FLC and alignment layers.

The capacitance C_{A} of a generic polyimide alignment layer having a thickness of ˜20 nm and a dielectric constant of ˜4 is approximately 200 nF/cm². For τ_{sw}= 1/720 s, which is a typical FLCOS frame period, and τᵥᵢₛᵢₒₙ= 1/30 s, the value of R₁ is set to the range 14 kΩ<R₁<0.3 MΩ for a cell area of 1 cm². For a typical FLC layer whose thickness is on the order of 1 μm, the electrical resistivity, ρ_{I}, of the FLC due to the motion of ionic charge carriers should correspondingly be in the range 140 MΩ·cm<ρ_{I}<3 GΩ·cm. In practice, the upper time constant limit of 1/30^{th} s may be excessively stringent, i.e. it may be visually acceptable for image sticking to persist for a larger fraction of a second so that electrical resistivities as large as ρ_{I}˜20 GΩ·cm may be acceptable.

The FLC within the pixels of a FLCOS display is predominately binary in character. The two available display states are bright and dark, when viewed using a suitable polarized light optical system. There is, nevertheless, a degree of analog response, and the exact polarizer orientation, relative to the FLCOS display, for an optimal dark state varies somewhat with drive voltage amplitude. Grayscale is achieved by controlling the fraction of time that a pixel is turned on (bright). The pixel is turned on and off at such a high rate that viewers see only the average brightness. A 10% “on” duty cycle appears nearly dark, a 50% duty cycle appears gray, while a 100% duty cycle produces maximum brightness. This is known as pulse width modulation (PWM) grayscale. Variations of a pulse width modulation can be used. For example, a positive pulse may be generated as a waveform with variable amplitude, including a basic positive pulse composed of a set of positive pulses.

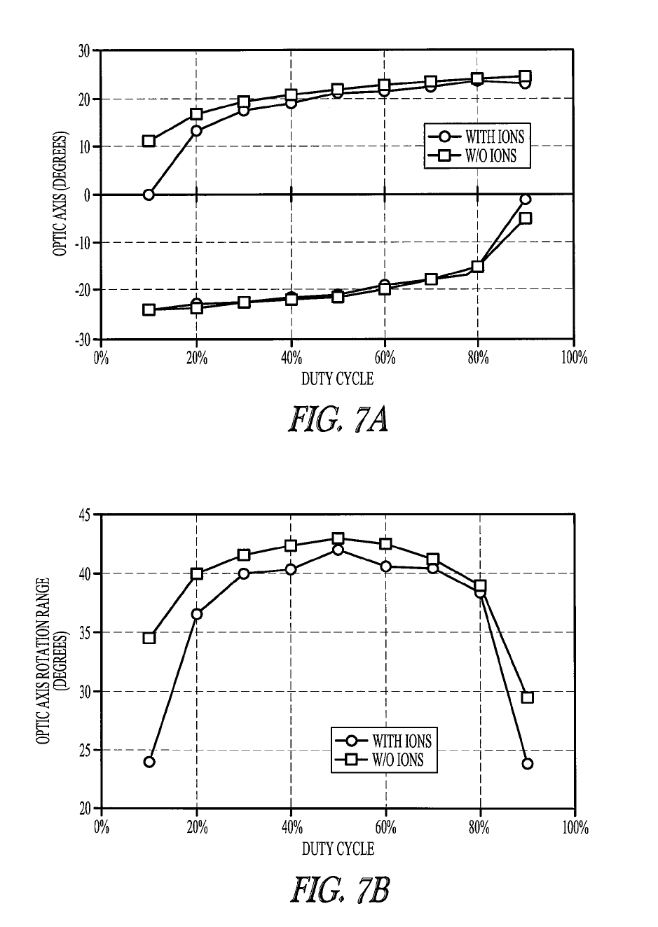

FIG. 5A shows idealized examples of drive waveforms applied to a pixel's electrodes with electrical duty cycles ranging from 10% to 90%. FIG. 5B shows illustrations of voltages appearing across the FLC layer corresponding to the drive waveforms of FIG. 5A. A voltage appearing across the FLC is equal to the drive voltage with its dc component removed, that is, the time averaged voltage of each waveform is zero. Due to the high pass character of the cell, only the ac part of the drive waveform appears across the FLC layer as shown in FIG. 5B. In a non-idealized cell, i.e. a real cell, the sharp voltage transitions shown in the “dc removed” cases of FIG. 5B would be rounded due to the circuit time constant ½R₁C_{A}. In FIGS. 5A-B, it is assumed that the optical system has been arranged such that positive voltages nominally produce a bright state and negative voltages nominally produce a contrasting dark state and that illumination is on continuously. If the FLC were to switch fully and instantaneously in response to changes in drive voltage polarity, then the duty cycle would correspond more precisely to apparent display brightness.

As shown in FIG. 5B, a practical limitation to applying the waveforms shown in FIG. 5A is due to the fact that the dominant (longest lasting) portion of the switching voltage across the FLC, with dc removed, tends toward zero as extremes of electrical duty cycle are approached (e.g. 5% or 95%). Consider the 10% duty cycle of FIGS. 5A-B, the voltage across the FLC layer (FIG. 5B) due to the −1 portion of the drive waveform (FIG. 5A) is reduced to −0.2, while the +1 portion of the drive waveform becomes 1.8. Thus, the voltage driving the FLC to its dark state becomes less effective. The FLC is less fully switched and switching takes significantly longer, which phenomenon the inventors have observed in laboratory measurements of FLC switching. As electrical duty cycle is reduced, a threshold is reached where the FLC is no longer driven effectively to its dark state. An analogous situation arises as the electrical duty cycle rises toward 100%. At duty cycles of 0% or 100%, zero volts is applied to the FLC layer, and a typical symmetric FLC cell may break up into randomly distributed patches of bright and dark (UP and DOWN domain states of the FLC).

The problem of duty cycle extremes can be ameliorated by not leaving the illumination on continuously. For example, suppose that the FLC just barely switches to an adequate dark state during the negative voltage portion of a 10% duty cycle drive waveform, such that electrical duty cycles <10% or >90% typically cannot be used. Instead of leaving the light on all the time, it can be turned on only during the 10%-90% portion of each cycle so that the pixel looks dark when driven by the 10% duty cycle waveform. As the drive waveform duty cycle grows from 10% to 90% the brightness increases monotonically to a maximum value greater than that obtainable when using the dc-compensation method. In this example, illumination is on for 80% of the drive waveform cycle (an 80% optical duty cycle), whereas when using dc-compensated drive the illumination is on only 50% of the time, giving a potential brightness gain in this case of 80/50=1.6.

The drive waveform used in FLCOS displays to show full color images is more complex than that of the above example, but fundamentally no different in its use of PWM gray scale. The above scheme can be implemented in a FLCOS display. In various embodiments, the degree of dc-compensation can be reduced. This reduction can be accomplished with respect to a stream of images being shown on the display, where image complements are inserted for one of every N images, where N is greater than 2. Note that N=2 would correspond to dc-compensation. As N is increased, there will be a limit beyond which an adequate dark state cannot be obtained for reasons given above for the 10% electrical duty cycle.

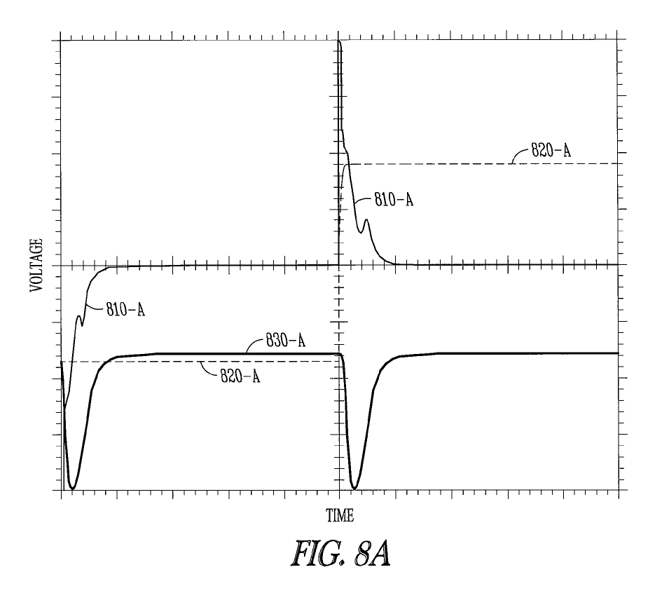

In various embodiments, a decay time for a FLC cell can be adjusted by forming a base FLC doped with ions to a level such that the ion dopant does not adversely affect the switching of the base FLC. Tests with added ionic material to enhance conductivity and without the added ionic material have been performed relative to optic axis rotation. FIG. 6 illustrates FLC optic axis orientations, θ₊ and θ₋, for positive and negative drive voltages.

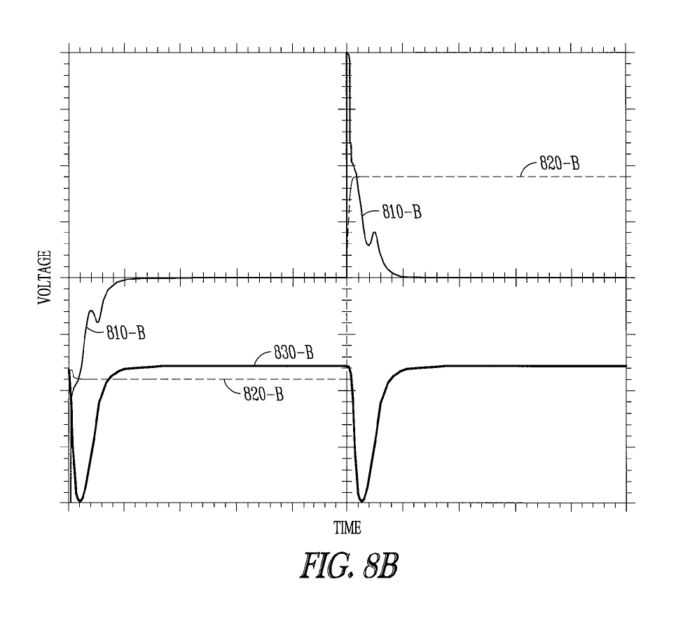

FIG. 7A is a graph showing optic axis orientations θ₊ and θ₋ vs. drive waveform duty cycle for FLC cells with and without added ionic conductivity. FIG. 7B is a graph showing the difference in optic axis orientations (θ₊−θ₋) vs. duty cycle to better highlight differences between the two cases of FLC cells with and without added ionic conductivity. In these tests, one cell was filled with a base FLC (labeled MX13058) having no added ionic conductivity and another cell was filled with the base FLC ion doped (labeled MX12918, MX12918 being an ion-doped version of MX13058). Both cells were FLCOS dummies, where FLCOS dummies are similar in physical structure to product microdisplays, but without the CMOS VLSI circuitry normally present in the silicon of the product microdisplays. The cells were driven with waveforms such as shown in FIG. 5A, with electrical duty cycles ranging from 10% to 90%, an amplitude of ±1.8V, at a frequency of 720 Hz, which is a typical FLCOS microdisplay frame rate. FLC optic axis positions for positive and negative drive voltages, θ₊ and θ₋ respectively, were measured just before each voltage transition to allow maximum settling time.

The ion-doped FLC shows reduced optic axis rotation compared to the undoped FLC as extremes of electrical duty cycle are approached. The effect of conductivity on optic axis position is not extreme in this example because the dopant concentration was kept to a relative minimum to have a beneficial degree of perceived image sticking reduction while, at the same time, minimally interfering with full switching of the FLC.

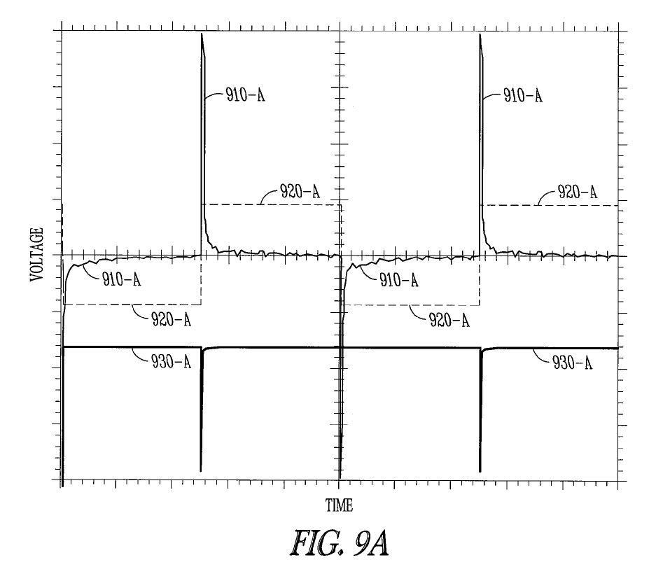

FIG. 8A shows measurements of applied drive cell voltage (curve 820-A), FLC cell electrical current (curve 810-A), and optical response (curve 830-A) vs. time for a base FLC without added ionic conductivity (MX13058). For FIG. 8A, time is shown as 200 μs/div for curve 810-A, curve 820-A, and curve 830-A. For curve 820-A, the voltage is displayed as 1 V/div. For curve 830-A, the voltage is displayed as 200 mV/div. For curve 810-A, the current monitor scale factor is 1 mA/V, which is displayed with a plot scale of 200 mV/div.

FIG. 8B shows measurements of applied drive cell voltage (curve 820-B), FLC cell electrical current (curve 810-B), and optical response (curve 830-B) vs. time for a similar base FLC cell ion-doped (MX12918). For FIG. 8B, time is shown as 200 μs/div for curve 810-B, curve 820-B, and curve 830-B. For curve 820-B, the voltage is displayed as 1 V/div. For curve 830-B, the voltage is displayed as 100 mV/div. For curve 810-B, the current monitor scale factor is 1 mA/V, which is displayed with a plot scale of 200 mV/div.

In both cases shown in FIGS. 8A and 8B, the drive waveform is a ±1.8 V square wave (50% duty cycle) with a 2 ms period. The optical response is the light intensity seen by a photodetector when using crossed polarizers, each cell in these cases is oriented such that it switches between two equally bright display states rather than between bright and dark, comprising substantially contrasting states. The optic axis swings symmetrically left and right of the polarizer orientation. The observed optic axis range was ˜40° without ions and ˜39° with ions.

Plots of FIGS. 8A-B for the two FLCs (with and without added ionic conductivity) look essentially the same. A double current peak due to switching of the FLC's polarization direction is seen when the voltage changes polarity (typical of FLC cells) after which the current (˜0 on this scale) and optical response are essentially constant until the polarity is again reversed. This shows that the quantity of ionic charge flow per unit area is small compared to 2P_{S}, where P_{S} is the FLC's spontaneous polarization density. This finding is consistent with the above comments regarding keeping dopant concentration low in order to avoid significant interference with FLC switching.

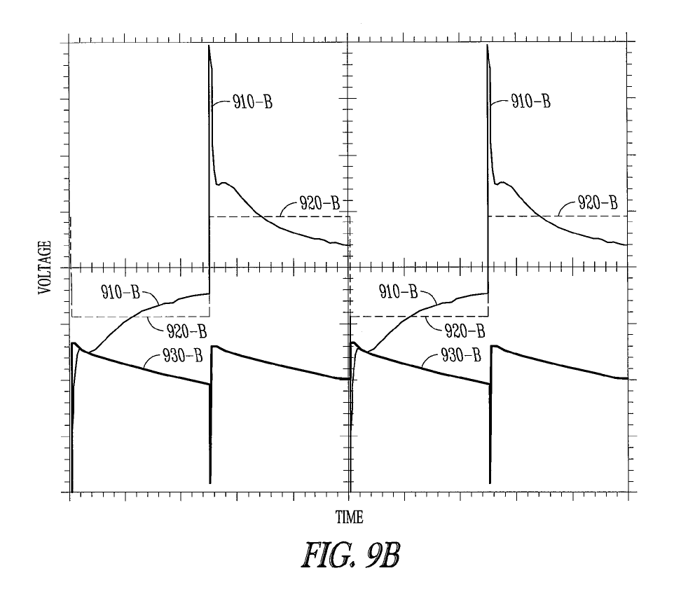

FIG. 9A shows measurements of applied drive cell voltage (curve 920-A), FLC cell electrical current (curve 910-A), and optical response (curve 930-A) vs. time for a base FLC without added ionic conductivity (MX13058) at a drive waveform having a higher period than the drive waveform for FIG. 8A. For FIG. 9A, time is shown as 20 ms/div for curve 910-A, curve 920-A, and curve 930-A. For curve 920-A, the voltage is displayed as 2 V/div. For curve 930-A, the voltage is displayed as 100 mV/div. For curve 910-A, the current monitor scale factor is 1 μA/V, which is displayed with a plot scale of 500 mV/div.

FIG. 9B shows measurements of applied drive cell voltage (curve 920-B), FLC cell electrical current (curve 910-B), and optical response (curve 930-B) vs. time for a similar base FLC cell ion-doped (MX12918) at a drive waveform having a higher period than the drive waveform for FIG. 8B. For FIG. 9B, time is shown as 20 ms/div for curve 910-B, curve 920-B, and curve 930-B. For curve 920-B, the voltage is displayed as 2 V/div. For curve 930-B, the voltage is displayed as 100 mV/div. For curve 910-B, the current monitor scale factor is 1 μA/V, which is displayed with a plot scale of 500 mV/div.

The drive waveform for the two FLCs of FIGS. 9A-B is a ±1.8 V square wave with a 100 ms period. FIGS. 9A-B provide a with and without ion comparison similar to that shown in FIGS. 8A-B, except that the drive period is set to 100 ms instead of 2 ms. FIGS. 9A-B show the difference between FLCs with and without added ions. The FLC without ions shows a substantially stable optical response and near zero electrical current between switching events. In contrast, the ion-doped FLC shows significant current flow and a drooping optical response due to decay of the voltage across the FLC layer. The total ionic charge flow per unit area (in 50 ms) is comparable to Pₛ in this case.

FIGS. 8A-B and FIGS. 9A-B illustrate two features with respect to the relaxation of using a dc-balance for FLC displays by implementing FLC cells having a decay time constant comparable to or less than less than a maximum time visually acceptable for image sticking to persist on the FLC. The decay time constant may be less than a minimum time at which image sticking is noticeable to a human viewer of the FLC. First, the time constant, ½R₁C_{A}, should be large enough that ionic charge flow through the liquid crystal does not appreciably interfere with FLC switching. FIGS. 8A-B shows that this condition is satisfied by the ion-doped FLC. Second, the FLC conductivity should be high enough to discharge the voltage across the FLC layer within a fraction of a second. FIGS. 9A-B demonstrates that this is achieved with the ion-doped FLC.

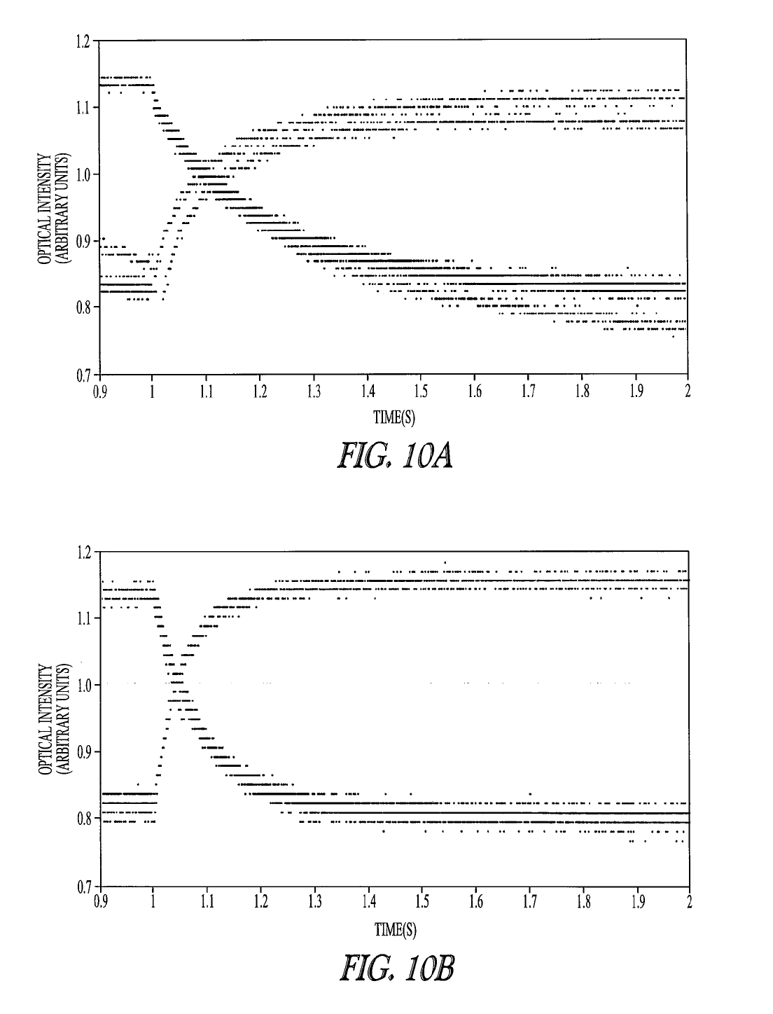

FIG. 10A shows results of changing duty cycles applied to a FLC with low ion concentration. FIG. 10B shows results of changing duty cycles applied to a FLC with high ion concentration. Low and high concentration are relative to each other, and are used with respect to concentrations that meet the two features discussed above as criteria. The ion concentration within base FLC cell ion-doped (MX12918) of FIGS. 8B and 9B is intermediate between the low concentration and high concentration of the two FLCs used in the tests with results shown in FIGS. 10A-B. These tests demonstrate that optic axis positions drift to new equilibrium positions in a fraction of a second in response to a change in duty cycle (i.e. fast decaying image sticking). The drift time corresponds to the length of time required for the average voltage across the FLC layer to return to zero, which is approximately ˜½R₁C_{A}. In these tests, the drive waveform consisted of 500 cycles of a 25% duty cycle waveform (2 ms period, ±1.8 V amplitude) alternating with 500 cycles of a 75% duty cycle waveform (±1.8V amplitude), i.e. the electrical duty cycle alternates between 25% and 75% with a frequency of 0.5 Hz.

In FIGS. 8A-B and FIGS. 9A-B, each FLC cell was oriented relative to polarizers such that the two switched states were of equal brightness, instead of switching between bright and dark (e.g. substantially contrasting states). For the tests of FIGS. 10A-B, each FLC cell was rotated slightly so that the two states had slightly different brightnesses, the plots in FIGS. 10A-B show how both brightness levels change following 25%-75% duty cycle transitions (at t=1 second in each plot). The FLC with a low concentration of ionic dopant, shown in FIG. 10A, takes about a half second or longer to equilibrate after a change in drive duty cycle, whereas the FLC with a high concentration, shown in FIG. 10B, equilibrates in about 0.2-0.3 seconds. Image sticking fades quickest in the FLC containing the higher concentration of ionic dopant.

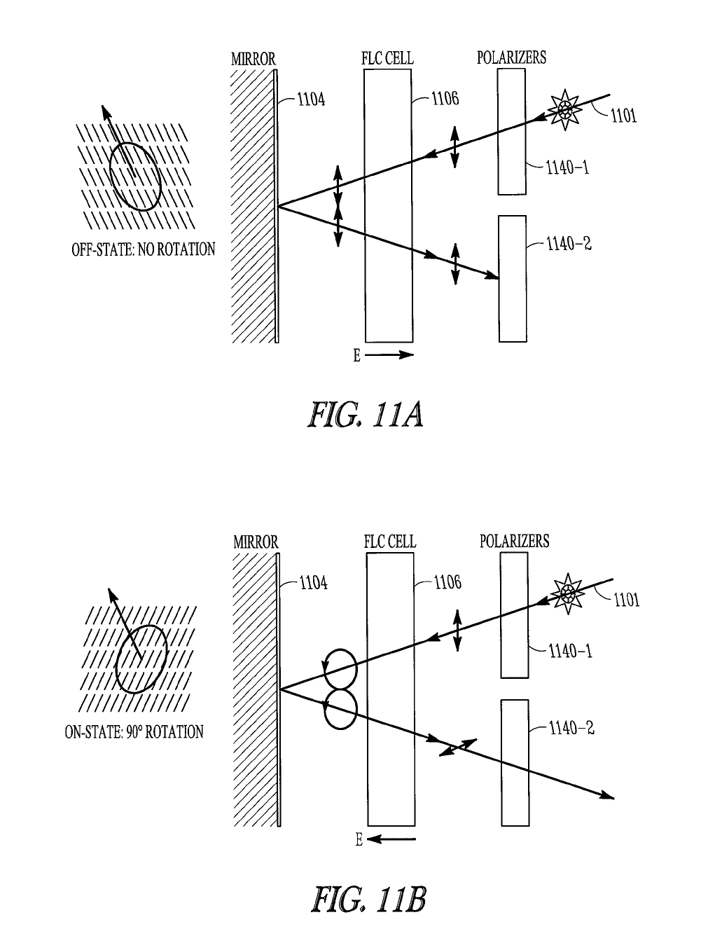

FIGS. 11A-B show an example representation of operation of a FLC cell 1106 with a set of polarizers 1140-1 and 1140-2. The optic axis of polarizer 1140-2 is substantially orthogonal to that of polarizer 1140-1. Incident unpolarized light 1101 contains a mix of polarization states, only that portion of the incident light whose state of linear polarization matches the optic axis orientation of polarizer 1140-1 is substantially transmitted through the polarizer. In the FLC's off state its optic axis is substantially parallel to the optic axis of polarizer 1140-1, and in the FLC's on state its optic axis is rotated substantially 45° away from being parallel to the optic axis of polarizer 1140-1. The thickness of the birefringent FLC layer is chosen so that it has an optical retardation of substantially 90°, i.e. it acts as a quarter wave retarder.

In FIG. 11A, FLC cell 1106 is in an off state such that after light passes through FLC cell 1106, is reflected by mirror 1104, and again passes through FLC cell 1106, its polarization state is substantially unchanged. This reflected light is reflected or absorbed at polarizer 1140-2 and does not pass through polarizer 1140-2. With no light passing through polarizer 1140-2, the output from the combined structure is optically dark.

In FIG. 11B, FLC cell 1106 is in an on state such that after passing through FLC cell 1106, being reflected by mirror 1104, and again passing through FLC cell 1106, its state of linear polarization is rotated substantially by 90°. The light's direction of linear polarization is substantially parallel to the optic axis of polarizer 1140-2 and can pass through that polarizer. With light passing through polarizer 1140-2, the output from the combined structure is optically bright.

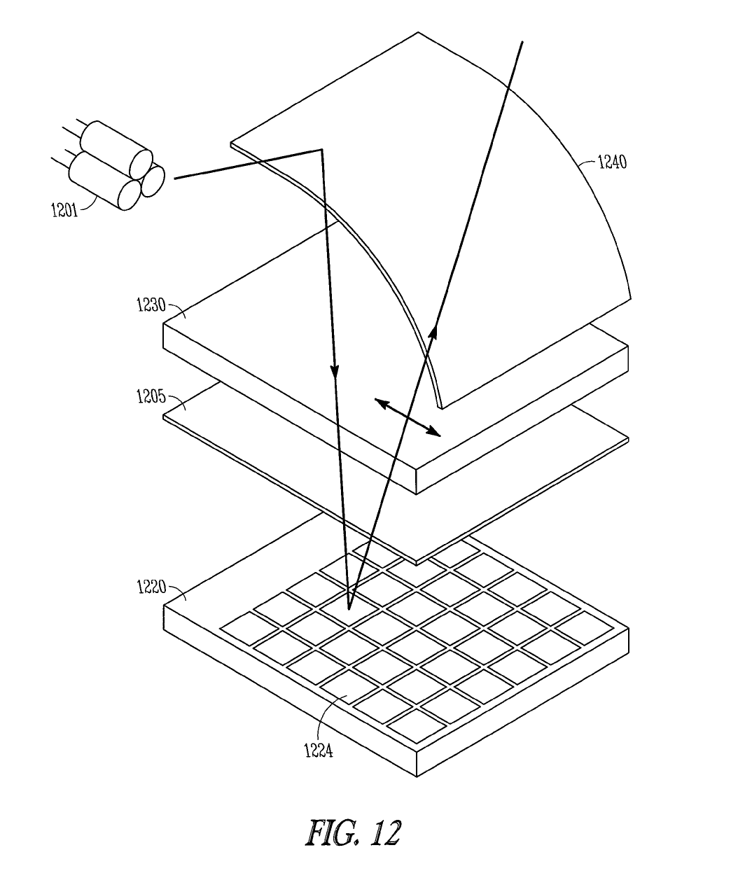

FIG. 12 shows an example representation of components for operation of FLC 1205. Light is provided by source 1201. Source 1201 can include LEDs for sequential color, where the LEDs generate red (R), green (G), and blue (B) light. The light from source 1201 can be directed to a polarizing beam splitter film 1240 that directs a polarized state of the light to window 1230 over FLC 1205 disposed over a circuit 1220. FLC 1205 may have a thickness of approximately 1 μm, though other suitably small thicknesses may be used. Circuit 1220 can be configured as a CMOS VLSI circuit including an array of pixels 1224. Pixels 1224 may be configured for digital operation. The polarized light passing through FLC 1205 is reflected from pixel 1224 back through FLC 1205. With FLC 1205 placed in a proper state, either on or off depending on the image to be displayed, using circuit 1220, the light passing through FLC 1205 directed to polarizing beam splitter film 1240 has a proper polarization to pass through polarizing beam splitter film 1240 when the pixel is in the “on” state.

In various embodiments, a ferroelectric liquid crystal display is formed including disposing a ferroelectric liquid crystal above an array of pixels on a substrate. An alignment layer can be disposed above the ferroelectric liquid crystal such that the ferroelectric liquid crystal arranged with the alignment layer has a decay time constant relative to operation in a circuit such that the decay time constant is comparable to or less than a maximum time visually acceptable for image sticking to persist on the liquid crystal display. The decay time constant may be less than a minimum time at which image sticking is noticeable to a human viewer of the liquid crystal display. The disposition of the ferroelectric liquid crystal can include selecting a ferroelectric liquid crystal having an electrical resistivity less than an upper electrical resistivity. This upper electrical resistivity can be set both by the capacitance of the alignment layer and by the decay time constant set comparable to or less than a maximum time visually acceptable for image sticking to persist on the liquid crystal display. The capacitance of the alignment layer can be fixed by using a selected material with a selected thickness as the alignment layer. The disposition of the ferroelectric liquid crystal can include using a base ferroelectric liquid crystal doped with ions as the ferroelectric liquid crystal. The doping level can be set to attain a desired conductivity of the ferroelectric liquid crystal in a cell for the display. Alternately, a material and a thickness of the alignment layer can be selected such that the decay time constant is comparable to or to or less than a maximum time visually acceptable for image sticking to persist on the display for a selected ferroelectric liquid crystal. The material for the alignment layer may be a polyimide. With a ferroelectric liquid crystal sandwiched between two alignment layers, the two alignment layers may be composed of different materials and thickness, where the decay time constant of the arrangement of the ferroelectric liquid crystal and the two alignment layers is comparable to or less than a maximum time visually acceptable for image sticking to persist on the display. The arrangement of the ferroelectric liquid crystal and the two alignment layers, including selection of materials and thicknesses, can be realized such that a corresponding decay time constant can also be greater than the switching time of the ferroelectric liquid crystal.

In various embodiments, techniques to control a decay time constant, similar or identical to those discussed herein, can be applied to nematic liquid crystals. Production of a nematic liquid crystal display may include deviations in the drive circuitry for the nematic liquid crystal display in which the drive circuit fails to provide a signal that is within tolerances to meet a zero dc average signal design parameter. To compensate for variations in tolerances in the production of a nematic liquid crystal display, such as deviations in the drive circuitry among others, parameters for the nematic liquid crystal and associated insulating material can be adjusted to control an associated decay time constant to limit possible image sticking to a time comparable to or less than a maximum time visually acceptable for image sticking to persist on the display. The decay time constant may be less than a minimum time at which image sticking is noticeable to a human viewer of the nematic liquid crystal display.

In various embodiments, a ferroelectric liquid crystal display is operated by applying a drive waveform to a cell of a ferroelectric liquid crystal display, where the cell includes a ferroelectric liquid crystal coupled to alignment layers. The arrangement of the ferroelectric liquid crystal and the alignment layers provides the cell with a decay time constant relative to operation in a circuit such that the decay time constant is comparable to or less than a maximum time visually acceptable for image sticking to persist on the display. The decay time constant can be less than a minimum time at which image sticking is noticeable to a human viewer of the display. This decay time constant may be generated by using a base ferroelectric liquid crystal doped with ions as the ferroelectric liquid crystal in the cell. Such a decay time constant can provide a decay time for operation of the ferroelectric liquid crystal display that is comparable to or less than an average time for detection of image sticking perceived with human vision. In some embodiments, operation of the ferroelectric liquid crystal display can include generating a stream of images on the ferroelectric liquid crystal display and inserting image complements for one of every N images in the stream, where N is an integer greater than 2. A pulse-width modulation waveform, or other appropriate waveform, may be applied as the drive waveform. Instead of leaving the light on all the time, it can be turned on only during the 10%-90% portion of each cycle so that the pixel looks dark when driven by the 10% duty cycle waveform. As the drive waveform duty cycle grows from 10% to 90% the brightness increases monotonically to a maximum value greater than that obtainable when using the dc-compensation method. However, the range of electrical duty cycles may vary from the example range of 10% to 90%. In various embodiments, with the electrical duty cycles ranging from a lower end to an upper end, the optical duty cycle can be set by the ends of the range for these electrical duty cycles. The optical duty cycle may vary about these ends to accommodate the switching speeds of the liquid crystal.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description.

What is claimed is:

1. An apparatus comprising:
a liquid crystal display including a liquid crystal coupled to a structure having an insulating material such that combination of the liquid crystal and the insulating material has a decay time constant less than or equal to a maximum time visually acceptable for image sticking to persist on the liquid crystal display.

2. The apparatus of claim 1, wherein the liquid crystal includes a nematic liquid crystal.

3. The apparatus of claim 1, wherein the liquid crystal display includes a cell containing a ferroelectric liquid crystal, the cell coupled to the insulating material, the insulating material being a portion of an alignment layer.

4. The apparatus of claim 3, wherein the ferroelectric liquid crystal is doped with ions.

5. The apparatus of claim 3, wherein the cell includes resistive material, in addition to the ferroelectric liquid crystal, that significantly contributes to the decay time constant.

6. The apparatus of claim 3, wherein the alignment layer has a capacitance and the ferroelectric liquid crystal has an electrical resistance such that the decay time constant is about one-half the product of the electrical resistance of the ferroelectric liquid crystal and a capacitance associated with the capacitance of the alignment layer.

7. The apparatus of claim 3, wherein the decay time constant is greater than a time to switch the ferroelectric liquid crystal between substantially contrasting display states.

8. The apparatus of claim 1, wherein the decay time constant is less than a minimum time at which image sticking is noticeable to a human viewer of the liquid crystal display.

9. The apparatus of claim 1, wherein the decay time constant is less than one-thirtieth of a second.

10. An apparatus comprising:
an array of pixels on a substrate; and
a ferroelectric liquid crystal arranged between two alignment layers in an electrical circuit with a pixel of the array, the arrangement of the ferroelectric liquid crystal and the two alignment layers having a decay time constant relative to operation in the electrical circuit such that the decay time constant is comparable to or less than a maximum time visually acceptable for image sticking to persist on a display.

11. The apparatus of claim 10, wherein the decay time constant is comparable to or less than a minimum time for detection of image sticking perceived with human vision.

12. The apparatus of claim 10, each alignment layer is formed of a polyimide and the ferroelectric liquid crystal has an electrical resistivity less than or equal to 20 GΩ·cm.

13. The apparatus of claim 10, wherein the electrical circuit includes a source to apply pulse-width modulation to the arrangement.

14. The apparatus of claim 10, wherein the electrical circuit includes a source to apply a signal to the pixels such that the pixels are in an on state with a duty cycle in the range from about 10% to about 90%.

15. The apparatus of claim 10, wherein the decay time constant is essentially set by capacitance of the alignment layers and electrical resistivity of the ferroelectric liquid crystal, the electrical resistivity of the ferroelectric liquid crystal controlled at least in part by motion of ionic charges.

16. The apparatus of claim 15, wherein the ferroelectric liquid crystal includes a base ferroelectric liquid crystal doped with ions.

17. An apparatus comprising:
a substrate;
an array of pixels on the substrate;
a first alignment layer above the array;
a ferroelectric liquid crystal on the first alignment layer;
a second alignment layer on the ferroelectric liquid crystal; and
a conductor coupled to the second alignment layer, the conductor arranged to operatively apply a signal across the first alignment layer and the second alignment layer with the ferroelectric liquid crystal arranged between the first alignment layer and the second alignment layer, the arrangement of the ferroelectric liquid crystal and the two alignment layers having a decay time constant relative to operation with a pixel of the array, the decay time constant less than or equal to a maximum time visually acceptable for image sticking to persist on a display.

18. The apparatus of claim 17, wherein the decay time constant is comparable to or less than a minimum time for detection of image sticking perceived with human vision.

19. The apparatus of claim 17, wherein the substrate includes a silicon substrate.

20. The apparatus of claim 17, wherein conductor includes a transparent conductor.

21. The apparatus of claim 20, wherein the transparent conductor includes indium tin oxide (ITO).

22. The apparatus of claim 17, the ferroelectric liquid crystal includes a base ferroelectric liquid crystal doped with ions.

23. A method of forming a ferroelectric liquid crystal display comprising
disposing a ferroelectric liquid crystal above an array of pixels on a substrate, the ferroelectric liquid crystal having an electrical resistivity; and
disposing an alignment layer above the ferroelectric liquid crystal, the alignment layer having a capacitance, wherein the ferroelectric liquid crystal arranged with the alignment layer has a decay time constant relative to operation in a circuit such that the decay time constant is less than or equal to a maximum time visually acceptable for image sticking to persist on a display.

24. The method of claim 23, wherein disposing the ferroelectric liquid crystal includes disposing a ferroelectric liquid crystal having an electrical resistivity less than an upper electrical resistivity, the upper electrical resistivity determined by the capacitance associated with using a selected material with a selected thickness as the alignment layer and by the decay time constant.

25. The method of claim 23, wherein disposing the ferroelectric liquid crystal includes disposing a base ferroelectric liquid crystal doped with ions.

26. The method of claim 23, wherein disposing the ferroelectric liquid crystal includes disposing the ferroelectric liquid crystal in a region having a top and a bottom, the region including a resistive element connecting the top with the bottom.

27. The method of claim 23, wherein the method includes selecting a material and a thickness of the alignment layer such that the decay time constant is comparable to or less than a minimum time at which image sticking is noticeable to a human viewer of the liquid crystal display.

28. The method of claim 27, wherein selecting a material includes selecting a polyimide.

29. A method comprising:
applying a drive waveform to a liquid crystal display, the liquid crystal display having an associated decay time constant relative to operation in a circuit such that the decay time constant is less than or equal to a maximum time visually acceptable for image sticking to persist on the liquid crystal display.

30. The method of claim 29, wherein the decay time constant is comparable to or less than a minimum time at which image sticking is noticeable to a human viewer of the ferroelectric liquid crystal display.

31. The method of claim 29, wherein liquid crystal display includes a cell including a ferroelectric liquid crystal coupled to an alignment layer.

32. The method of claim 31, wherein the ferroelectric liquid crystal includes a base ferroelectric liquid crystal doped with ions.

33. The method of claim 31, wherein the method includes:
generating a stream of images on the ferroelectric liquid crystal display; and
inserting image complements for one of every N images in the stream, N being greater than 2.

34. The method of claim 29, wherein applying a drive waveform includes applying pulse-width modulation.

35. The method of claim 29, wherein the method includes maintaining illumination of the cell as the drive waveform places a pixel in an on state with a duty cycle in the range from about 10% to about 90%.
